(19) United States
(12) Patent Application Publication
(10) Pub. No.: US 2012/0222501 A1
(43) Pub. Date: Sep. 6, 2012

(54) CARRIER FRAME AND METHOD

(76) Inventor: Allan David Morrison, Acacia Ridge (AU)

(21) Appl. No.: 13/473,061

(22) Filed: May 16, 2012

Related U.S. Application Data
(62) Division of application No. 11/933,817, filed on Nov. 1, 2007.

(51) Int. Cl. G01N 1/00

(52) U.S. Cl. 73/864

(57) ABSTRACT

A sample storage system and method for transporting a medium containing a biological sample. In one aspect the system includes a generally U-shaped carrier frame adapted to facilitate the insertion of a sampling medium into the carrier. The carrier may be configured for use with an automated sampling and storage system.

### FIELD OF THE INVENTION

The present invention relates to the sampling of materials for analysis. In particular, although not exclusively, the present invention relates to a system and method for securely holding biological samples for sampling, automated processing and storage of the same.

### BACKGROUND OF THE INVENTION

Biological samples are often dried on media, such as filter paper. This has advantages over the use of samples in liquid form, from transportation and storage viewpoints.

Prior sample storage devices have been used where a piece of media is incorporated into a card with a cardboard surround. In theory, the objective of doing so has been to provide a support structure for the filter paper so that handling of the card is easier and potentially able to be automated. It also reflects the fact that the filter paper is more expensive than the cardboard surround material.

In practice, when some liquid samples such as blood are applied to the media, and especially filter paper, the drying of the liquid sample creates such force that the media is bent away from its notionally flat plane, and in so doing, also causes to bend the cardboard surround. The more liquid sample that is applied to the media, the more it is likely that in the drying process, the media and cardboard surround will be bent, thus warping the cardboard frame and making it unsuitable for automated storage and retrieval.

Another drawback to cardboard surrounds is that given the available manufacturing techniques, the cardboard surround may de-laminate as a result of the drying of the liquid sample, the bending of the cardboard surround, and generally as a result of handling.

As a result of the bending of the cards and/or possible de-lamination, automated handling of these sample cards is difficult, and therefore costly, and in some cases, impossible.

### SUMMARY

In one preferred aspect, the present invention includes a frame to which a sample card can be attached, and in so doing, force the card into a generally horizontal plane. Preferably, the frame is constructed of a material and design to achieve sufficient strength to overcome forces tending to bend of the card.

A number of possible embodiments of the frame are envisaged, including a whereby the frame is attached to one side of a card, or both sides of a card.

In a preferred embodiment, the frame incorporates a track or channel into which the card may be slotted.

The design of the frame is preferably such that during the loading of the card, and after the card is loaded, no part of the frame can come in contact with the sample material dried on the media, thus avoiding possible cross-contamination.

It is envisaged that a card could be loaded into a frame, either manually, or using automated methods.

In one preferred embodiment, the cards are loaded into frames and are retained permanently in place in the frame. This can be achieved through various means, including in one embodiment, the use of one or more pins which could be pressed through the frame and card, but not extending beyond the boundaries of the frame. Other possible means are envisaged.

In a further preferred embodiment, it is envisaged that the card may be loaded into the frame, only for the purposes of processing, and then removed from the frame, allowing the frame to be re-used with subsequent cards.

Various techniques of holding the cards temporarily in place, in the frame, are envisaged. In one preferred embodiment, the width of the channel in the channelled frame is not significantly different from the thickness of the card. When the card is loaded into the channelled frame, the lateral forces in the card that have caused the card to bend, exert sufficient pressure on the inner walls of the channelled frame so that the card is held in place in the frame with sufficient force to allow processing of the card loaded in the frame to occur successfully.

In a further preferred embodiment, the frame is of such a design that it is able to be loaded into a storage device, designed to hold multiple frames, loaded with cards.

In a further preferred embodiment, the design of the frame is adapted so that an automated or semi-automated handling system grips the frame.

In another further preferred embodiment, the frame is configured so that it is held with sufficient force in a magazine or other device, such as to prevent the frame being dislodged through the action of gravity.

In a further preferred embodiment, the frame is in the form of a three-sided device. This provides for ease of access to the media, given the difficulties that could arise with some processing equipment not being able to accommodate the height of the frame when accessing the media.

In one preferred application of the invention, bent cards with dried sample are loaded either manually or automatically into frames, and those frames are then inserted either manually or automatically into a magazine, and are able to hold multiple frames. The magazine is preferably configured to engage with the frame to ensure that the frame does not fall from the magazine, regardless of the orientation of the magazine.

The magazine is then loaded, either automatically or manually onto processing equipment such as an automated punch instrument. As part of the operation of the instrument, automated gripping devices grip the frame and move the frame loaded with the card through the processing operation, returning the frame loaded with the card, to the magazine.

The present invention in one preferred aspect provides for a sample storage system for transporting a biological sample, the system including a card for retaining the biological sample, the card having an upper face, a lower face and side portions; and a frame including a front base portion and two opposed side leg portions extending from the front base portion, each of the side leg portions terminating in a free end. The side leg portions are spaced apart from one another to form a recess configured to allow access to both faces of the card when the card is in the frame.

In a further preferred aspect, the invention provides for a frame for transporting a medium for retaining a biological sample, the frame including a front base portion and two opposed side leg portions extending from the front base portion. The front base portion and side leg portions lie generally in a horizontal plane. Each of the side leg portions terminate in a free end. The side leg portions are spaced apart from one another to form a recess configured to allow access to the medium when the medium is in the frame. Each of the side leg portions has a track for retaining a portion of the medium. The track of each leg portion is open to the recess.

In another preferred aspect, the present invention provides a method for obtaining a biological sample, the method including inserting a card into a generally U-shaped frame having an open end; collecting the biological sample; retaining at least a portion of the biological sample on the card; and inserting the frame into a storage facility having a plurality of docking stations.

### BRIEF DESCRIPTION OF THE FIGURES

FIG. 1 is a top perspective view of a frame for transporting a biological sample in accordance with one preferred embodiment of the present invention.

FIG. 2 is a front perspective view of the frame of FIG. 1.

FIG. 3 is top plan view of the frame of FIG. 1.

FIG. 4 is a rear view of the frame of FIG. 1.

FIG. 4A is an enlarged partial rear view taken along section A of FIG. 4.

### DETAILED DESCRIPTION OF THE DRAWINGS

Alternative embodiments of the invention will be apparent to those skilled in the art from consideration of the specification and practice of the invention disclosed herein. It is intended that the specification and examples be considered as exemplary only, with a true scope and spirit of the invention being indicated by the claims which follow. Wherever possible, like numbers will refer to like parts.

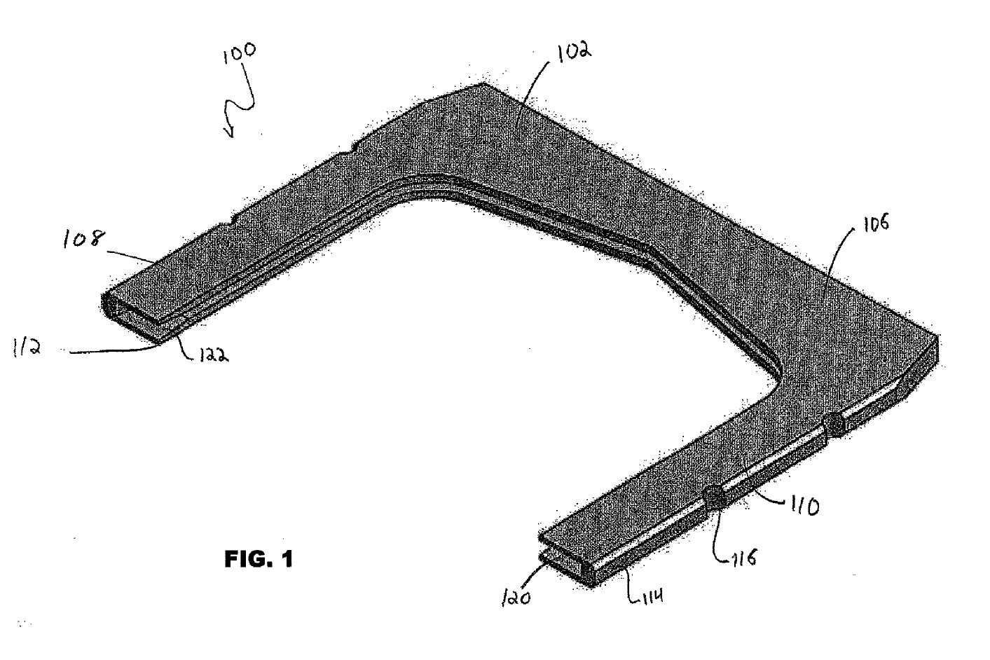

FIGS. 1 to 4A show a carrier frame 100 in accordance with a preferred embodiment of the present invention. Frame 100 includes an upper surface 102, a lower surface 104, a front end base portion 106, a pair of side leg portions 108, 110 extending from base portion 106, and an open rear end 112.

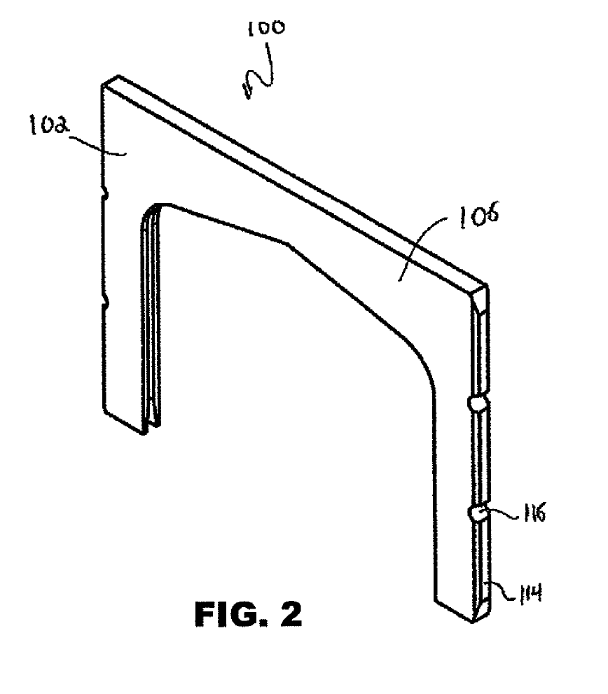

As shown in FIGS. 1 and 2, frame 100 includes a side surface 114 between upper surface 102 and lower surface 104. Side surface 114 preferably includes one or more indentations 116. Indentations 116 are preferably shaped as notches configured to facilitate selected movement of frame 100 within a storage facility or sampling device.

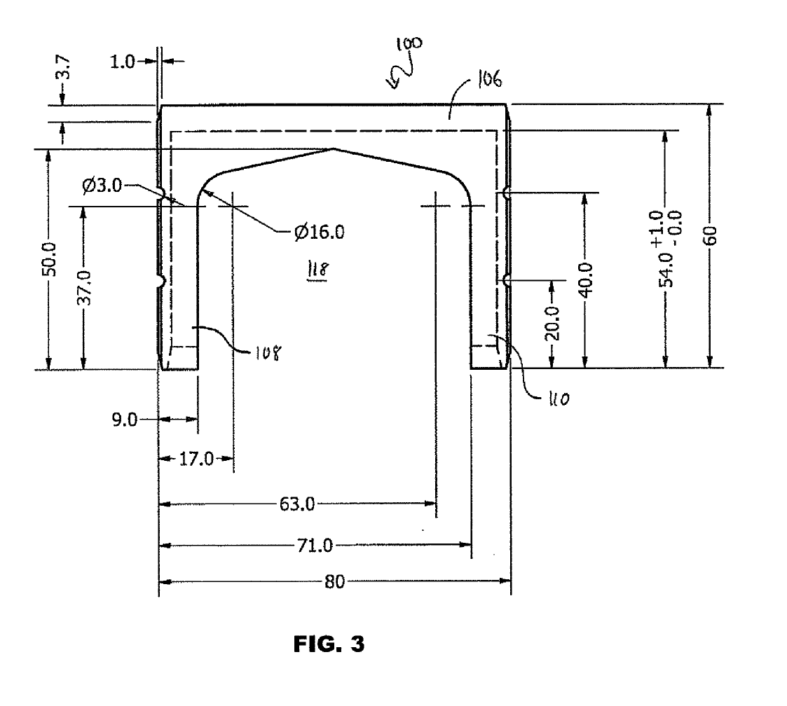

Referring to FIG. 3, front end base portion 106 and side leg portions 108, 110 preferably form a generally U-shaped configuration when viewed from above. Frame 100 preferably has an interior perimeter that forms a recess 118 that exposes a majority of the upper and lower faces of a sampling medium for retaining a biological sample, such as a paper filter card or swab, when inserted into frame 100. Unless otherwise noted, the frame will be described in relation to its use with a filter card, though it will be appreciated that the frame may be adapted for use with other sampling mediums. The U-shape of frame 100 permits easy access to the card held within the frame.

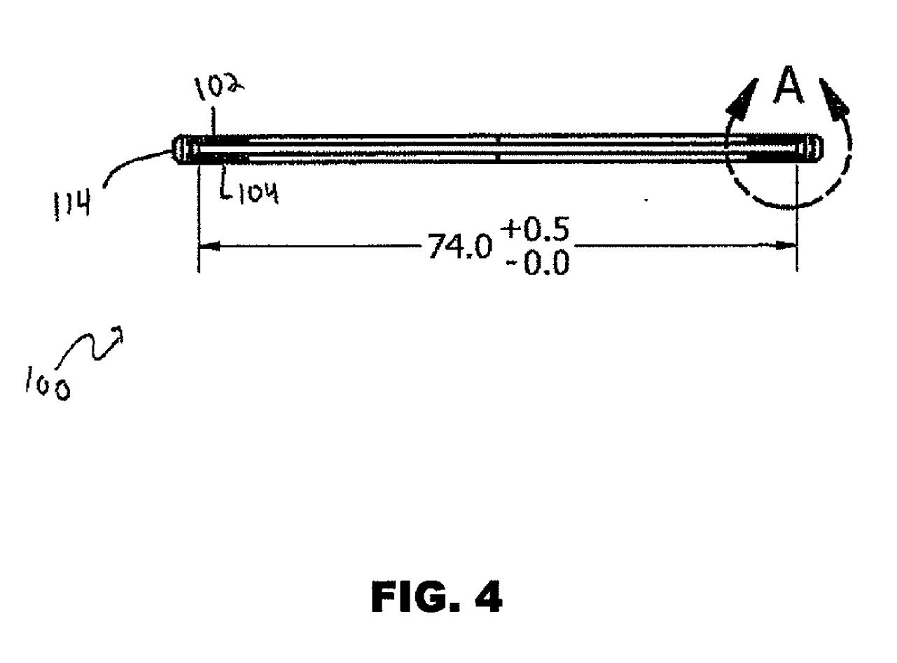

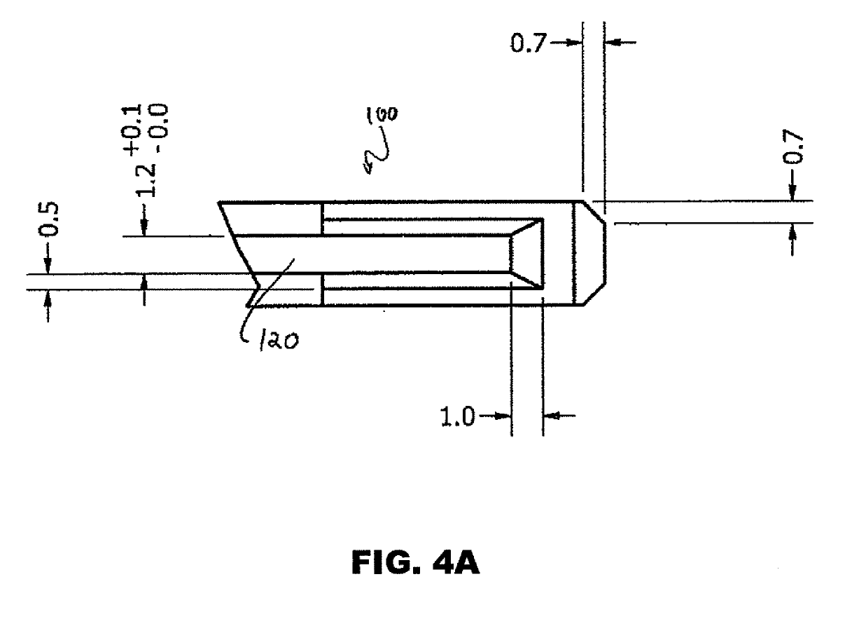

As shown in FIGS. 1 and 4A, frame 100 preferably includes a groove, track or channel 120 configured to hold the card. Groove 120 preferably includes a convergence 122 proximate open rear end portion 112 to facilitate insertion of the card into the frame. The height of the groove is preferably configured for a friction fit with the card to be inserted therein. It will be appreciated that the frame may be configured in other ways to retain the card. For example only, the frame may include a plurality of upper and lower resilient fingers, tabs or hinges adapted to hold the card therebetween.

Frame 100 is preferably constructed from a water-proof material such as a plastic or metal material. Preferably the material is of such strength so that if a paper filter card held within the frame becomes damp, frame 100 will assist to prevent the filter card from bending while the card dries. Maintaining a generally planar card configuration facilitates the delivery and storage of the filter card within a storage and sampling system, an example of which is described in U.S. patent application Ser. No. 10/648,088 and International Patent Application No. PCT/AU99/00485 (WO 99/65625), the contents of both being incorporated herein by reference.

Preferred dimensions are set forth below, although it will be appreciated that the dimensions may be varied as suitable for the intended application. Frame 100 preferably has an exterior width from side to side of approximately 80 mm. The interior width is approximately 74 mm from the side walls of groove 120. Frame 100 preferably has an external length of approximately 60 mm from the front end to the rear end and an internal length of approximately 54 mm from the front end to the rear end. Groove 120 preferably has a height of approximately 1.2 mm. The width of each leg is approximately 9 mm. The thickness of the wall of each leg between the side wall of groove 120 and the exterior side surface of the leg is approximately 3 mm. The thickness of the wall at front end portion 106 between groove 120 and the exterior front surface is approximately 6 mm. Frame 100 preferably has an overall height from upper surface 102 to lower surface 104 of approximately 3.2 mm. It will be appreciated that these dimensions are representative only and may be varied as appropriate.

Having described the preferred components of the carrier frame, a preferred method of use will now be described with reference to FIGS. 1 and 4. In a preferred aspect the present invention is configured for use with biological samples that may be used in medical diagnostic tests. For example, medical tests may be conducted using samples of blood, saliva or urine. The samples may comprise dried blood, saliva or urine retained by a piece of paper card or a swab.

A user inserts the card into frame 100 by aligning the card with the frame so that the card will slide into groove 120 through open rear end 112. Once the card is held to the frame, the user may collect a sample, such as a biological sample, which is then retained to the card. The frame containing the card is inserted into a docking station of a storage device preferably configured to store multiple frames. The frame may also be inserted into a magazine adapted to carry multiple frames, the magazine being itself insertable into a storage device.

The processing of the samples may be conducted by withdrawing the frame from the storage device and/or magazine and transporting the frame to a location where the sample may be examined. A selected portion of the sample is punched a portion of the card, the punched portion being removed for analysis. The remaining sample may be returned to the storage device by re-inserting the frame into one of the docking stations of the storage device for further storage and/or analysis. The frame is preferably configured to permit handling by automated devices such as a robotic arm, which can grasp the frame and manoeuvre the frame into an assigned docking station of the storage device or portion of the magazine.

It will be appreciated that the steps described above may be performed in a different order, varied, or omitted entirely without departing from the scope of the present invention. For example, a sample may be collected prior to attaching the card to the frame.

The foregoing description is by way of example only, and may be varied considerably without departing from the scope of the present invention. Various aspects of the carrier frame may be ramped or otherwise configured for easier handling. For example, the front base portion may be ramped to facilitate insertion into a docking station. The frame may include a lock to retain the sample medium within the frame. The frame may be configured to permanently secure the card. For example, the frame may be combined with one or more pins to secure the card to the frame. The groove may include one or more protrusions or ratchetings configured for one-way insertion to facilitate insertion of the card into the frame and inhibit its removal from the frame.

The frame may include a memory to record the number of times the sample has been accessed, suitably including the time and date of each accession. This record can be achieved by using a form of electronic memory, such as non-volatile RAM, which is updated upon docking with a testing apparatus or storage device. If required, the identity or location of the particular testing apparatus or storage device may also be recorded. The electronic memory may also include sample identification data in some embodiments or be associated with an RFID tag. A more simplified record may merely entail using a mechanical counter which is incremented upon accessing the compartment.

The carrier frame may include an identifier. For example, an identification label carrying a barcode may be affixed on the exterior of the carrier. In another example, the identifier may be electronic such as a radio frequency identification (RFID) tag.

The features described with respect to one embodiment may be applied to other embodiments, or combined with or interchanged with the features other embodiments, as appropriate, without departing from the scope of the present invention.

Advantageously the present invention will preferably permit the rapid processing of a large number of samples in comparison to the current practice.

While the present application has been described in relation to the analysis of biological samples persons skilled in the art will readily understand that it will have applications in other fields, such as environmental monitoring.

It will of course be realised that the above has been given only by way of illustrative example of the invention and that all such modifications and variations thereto as would be apparent to persons skilled in the art are deemed to fall within the broad scope and ambit of the invention as herein set forth.

1-11. (canceled)

12. A method of obtaining a biological sample, the method comprising:
inserting a card into a generally U-shaped frame having an open end; collecting the biological sample;
retaining at least a portion of the biological sample on the card; and
inserting the frame into a storage facility having a plurality of docking stations.

13. The method of claim 12, wherein the step of inserting a card includes sliding the card into the frame through the open end of the U-shape.

14. The method of claim 12, wherein the step of inserting the frame includes sliding the frame into one of the docking stations.

15. The method of claim 12, further comprising the step of withdrawing the frame from the storage facility.

16. The method of claim 15, further comprising the step of punching a portion of the card while the card is fixed to the frame.

17. The method of claim 16, further comprising the step of processing the portion punched from the card to generate an analysis of the sample.

18. The method of claim 15, further comprising the step of re-inserting the frame into one of the docking stations.

19. The method of claim 12, wherein the step of inserting a card includes inserting the card into a frame that is made of a water-proof material.
